(19) United States
(12) Patent Application Publication
(10) Pub. No.: US 2025/0327702 A1
(43) Pub. Date: Oct. 23, 2025

(54) HANDHELD FISH SCALE

(71) Applicant: Rapala VMC Oyj, Helsinki (FI)

(72) Inventors: Meng Da Liu, Inver Grove Heights, MN (US); Jeremy Michael Grayson, Minneapolis, MN (US)

(21) Appl. No.: 18/641,138

(22) Filed: Apr. 19, 2024

(51) Int. Cl. G01G 19/18; G01G 19/56

(52) U.S. Cl. CPC G01G 19/18; G01G 19/56

(57) ABSTRACT

A handheld fish scale is provided. The handheld scale includes a rotatable alignment element which provides for the self-alignment of the weight gauge components of the handheld scale and the item being weighed irrespective of the position in which a user holds the body of the handheld scale. The handheld fish scale can include a scale body, a weight gauge assembly, and a rotatable alignment element including a hemispherical rotational element. The hemispherical rotational element is in rotational contact with the scale body.

### FIELD

The present disclosure relates generally to a handheld portable scale and, more particularly, to a handheld fish scale. The handheld scale that is the subject of the present disclosure relates to a scale assembly that can be self-aligning with a rotatable alignment element which provides for the self-alignment of the weight gauge components of the handheld scale and the item being weighed irrespective of the position in which a user holds the body of the handheld scale.

### BACKGROUND

Handheld portable scales are utilized to weigh certain articles, such as fish. Fish scales are used to weigh fish for numerous purposes to include for an angler to report the success of their catch, for scoring within competition or for certain scientific and/or conservation purposes. Portable fish scales are often used by anglers during catch-and-release fishing. Therefore, it can be advantageous to weigh a fish quickly and accurately so that the fish may be promptly released, thereby decreasing the likelihood of stress or injury to the released fish.

Drawbacks exist with respect to portable scales, including handheld portable fish scales. For instance, the accuracy of measurements using a portable scale can be negatively impacted by numerous conditions such as movement of the article being weighed, including the movement of a live fish being weighed. Additionally, the accuracy of a portable scale can be negatively impacted by misalignment of the article being weighed with, or in comparison to, certain components or portions of the portable scale. For instance, if the article being weighed and the scale are both not in vertical alignment, or near vertical alignment, the portable scale may give an inaccurate reading. Inaccurate readings could be caused by friction or binding of certain components that occur during misalignment of the article being weighed and the weight gauge components (e.g., the scale, strain gauge, or other weight measuring components) of the portable scale. Additionally, because some anglers fish alone or are accompanied by others who may not be capable of assisting in the process of weighing a fish, it can be difficult or impractical to obtain accurate weights of an angler's catch. These drawbacks or challenges can decrease the enjoyment of angling or decrease the usefulness of a handheld scale.

Accordingly, it would be advantageous to have a handheld portable fish scale that can be operated by one person, can be used or held by hand, and/or which has features providing for or permitting self-alignment of the weight gauge components of the portable scale and the item being weighed, irrespective of the position at which a user holds or positions the body of the portable scale and irrespective of the position or movement of the item being weighed.

For these reasons an improved portable scale having rotatable alignment features (e.g., a rotatable alignment element or rod) providing for self-alignment of the weight gauge components of the scale and the item being weighed, irrespective of the position in which a user holds the body of the scale, would be advantageous, appreciated and useful.

### BRIEF DESCRIPTION

Aspects and advantages of embodiments of the present disclosure will be set forth in part in the following description, or may be learned from the description, or may be learned through practice of the embodiments.

Variations and modifications can be made to these example aspects of the present disclosure. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 depicts a handheld fish scale according to exemplary embodiments of the present disclosure.

FIG. 2 depicts a side profile view of the handheld fish scale of FIG. 1.

FIG. 3 depicts a side sectional view of the handheld fish scale of FIG. 1 taken along the A-A section line of FIG. 2.

FIG. 4 depicts a bottom perspective view of the body of the handheld fish scale of FIG. 1, with the weight gauge assembly removed for clarity.

FIG. 5 depicts a partial bottom perspective sectional view of the handheld fish scale of FIG. 1 taken along the B-B section line of FIG. 2.

FIG. 6 depicts a perspective view of a rotatable alignment element of the handheld fish scale of FIG. 1.

FIG. 7 depicts a sectional view of the rotatable alignment element of FIG. 6 taken along the C-C section line of FIG. 6.

FIG. 8 depicts a partial side perspective view of the self-aligning handheld fish scale of FIG. 1 with the second handle section removed for clarity.

FIG. 9 depicts a partial side perspective view of the self-aligning handheld fish scale of FIG. 1, with the second handle section removed for clarity and with the weight gauge assembly removed for clarity.

FIG. 10 depicts a partial cutaway view of a handheld fish scale according to exemplary embodiments of the present disclosure.

Repeat use of reference characters in the present specification and drawings is intended to represent the same or analogous features or elements of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise. As used herein, terms of approximation, such as “approximately,” “substantially,” or “about,” refer to being within a ten percent margin of error.

Aspects of the present disclosure are directed to a handheld fish scale. The fish scale can include a scale body, a weight gauge assembly, and a rotatable alignment element. The rotatable alignment element can include a hemispherical rotational element, a base, and a shaft extending between the hemispherical rotational element and the base. The hemispherical rotational element can be in rotational contact with the scale body. The base can be attached to the weight gauge assembly.

The rotatable alignment element of the present disclosure can also include a glide surface, a rim, and an inner surface forming a bowl. The shaft of the rotatable alignment element can include a channel that extends from the inner surface of the rotatable alignment element to the base.

The scale body can include a first handle section with a first cutout and a second handle section with a second cutout. The first handle section can be attached to the second handle section. When the handle sections are attached, the first cutout and the second cutout form a passageway and a handle cavity. The first handle section and the second handle each include an outer handle wall and an inner handle wall and wherein each of the inner walls form a handle cavity. The hemispherical rotational element can be positioned within the handle cavity and the shaft can extend through the passageway. The scale assembly can include one or more conductors extending between a power source and the weight gauge assembly through the channel of the rotatable alignment element.

The first handle section can also include an alignment stop boss extending from the inner wall of the first handle section towards the inner wall of the second handle section. Similarly, the second handle section further comprises an alignment stop boss extending from the inner wall of the second handle section towards the inner wall of the first handle section.

The rotatable alignment element can also include a guard extending from the rim. The guard can include a single protrusion or a plurality of protrusions extending from the rim. The guard includes one or more striking surfaces.

The weight gauge assembly of the scale can include a front panel, a rear panel and a plurality of walls extending between the front panel and rear panel. The plurality of walls, front panel and rear panel form a gauge enclosure and the base of the rotatable alignment can be attached (in some embodiments, immovable) to an inner surface of, at least, one of the plurality of walls of the gauge enclosure. A strain gauge can be located within the gauge enclosure.

With respect to the handheld fish scale assembly of the present disclosure, the guard and stop boss are positioned within the handle cavity and oriented with respect to one another to prevent the weight gauge assembly from coming into physical contact with the scale body. In other embodiments of the handheld scale of the present disclosure, the scale can include a scale body, a weight gauge enclosure with a weight tab and a rotatable alignment element extending between the scale body and weight gauge enclosure. The rotatable alignment element of the handheld scale can be configured to cause the weight gauge and weight tab to remain in a vertical position (e.g., in vertical alignment) irrespective of the position of the scale body.

Referring now to the figures, example aspects of the present disclosure will be discussed in greater detail.

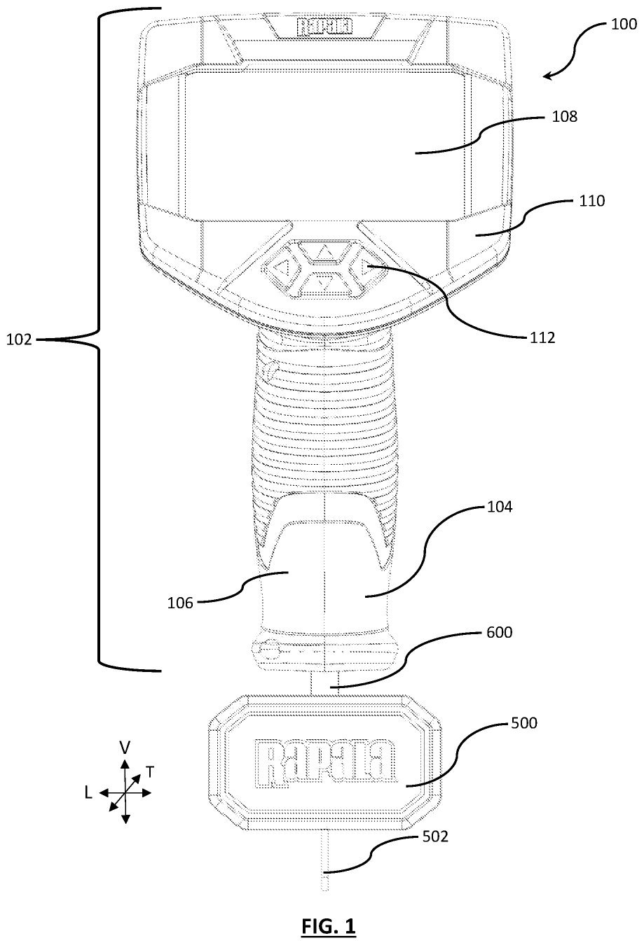

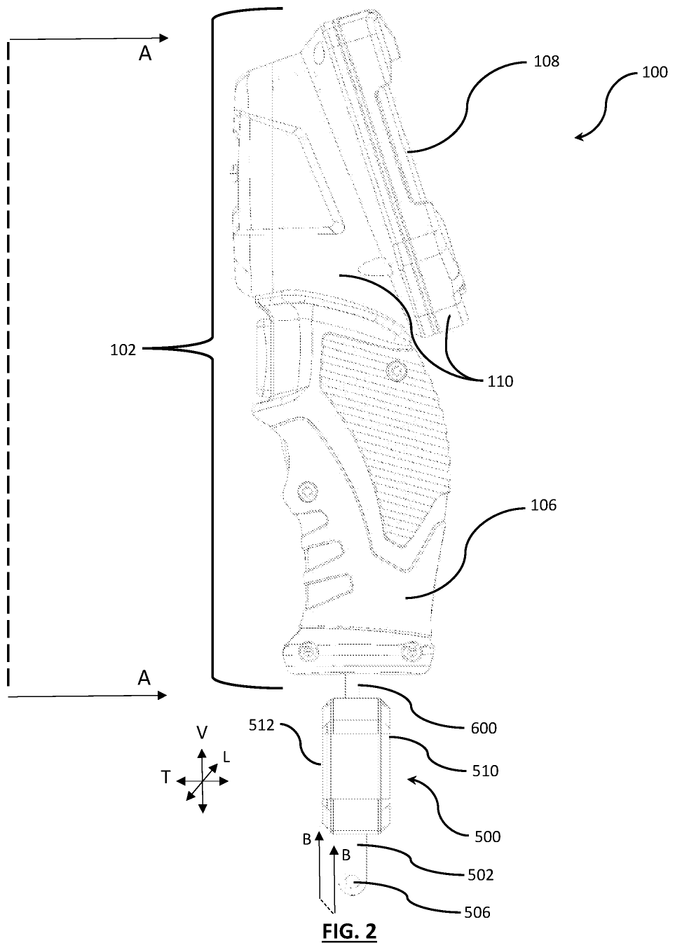

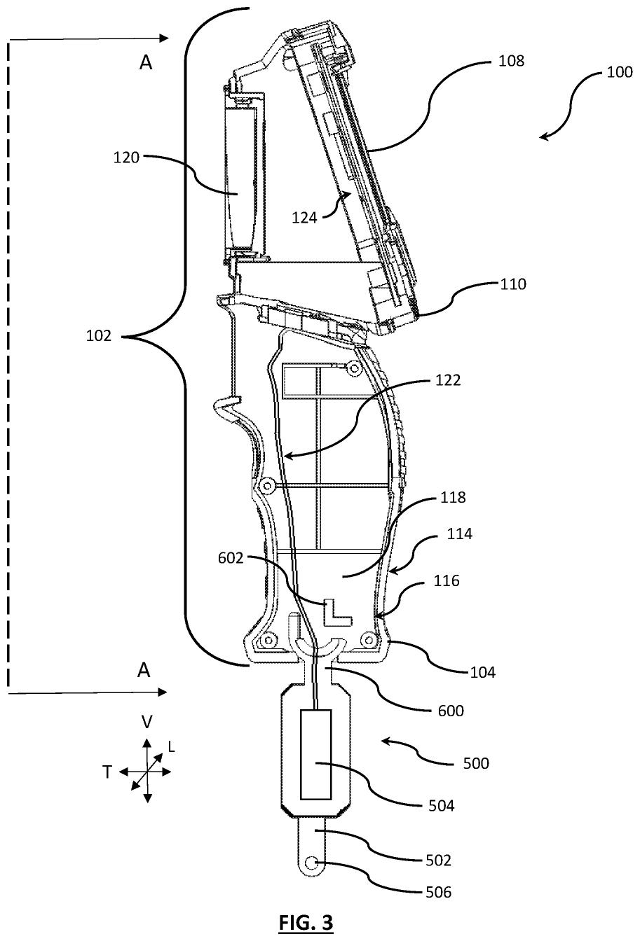

Referring generally to FIGS. 1 through 9. FIG. 1 depicts a handheld fish scale 100 according to exemplary embodiments of the present disclosure. FIG. 2 depicts a side profile view of the handheld fish scale 100 of FIG. 1. FIG. 3 depicts a side sectional view of the handheld fish scale of FIG. 1 taken along the A-A section line of FIG. 2. The handheld fish scale 100 defines a vertical direction V, a lateral direction L, and a transverse direction T. The vertical, lateral, and transverse directions V, L, and T are mutually perpendicular and form an orthogonal direction system.

Self-aligning handheld fish scale 100 includes a scale body 102. It should be appreciated that the ornamental shape of scale body 102 may be comprised of another ornamental shape or configuration. Scale body includes a first handle section 104, a second handle section 106, a display screen 108, a display frame 110 and control buttons 112. The first handle section 104 and/or second handle section 106 can be integrally formed with display frame 110. The first handle section 104 and/or second handle section 106 can also be mechanically attached to one another and/or display frame with screws, bolts, glue, tabs, or another known method of mechanical attachment. First handle section 104, second handle section 106, and display frame 110 can be formed or manufactured from plastic, metal, or any other rigid material. First handle section 104 and second handle section 106 are attached below, and extend away from, display frame 110 in a vertical direction V.

The first handle section 104 and second handle section 106 each include an outer wall 114 and inner wall 116. The inner wall 116 of first handle section 104 and inner wall 116 of second handle section 106 form a handle cavity 118. Handle sections 104 and 106 can also be integrally formed with display frame 110. Handle cavity 118 is a void formed within scale body 102.

Handheld fish scale 100 includes an alignment stop boss 602. Alignment stop boss 602 extends, in a lateral direction L, from the inner wall 116 of first handle section 104 towards the inner wall 116 of second handle section 106. Alignment stop boss 602 may be an “L” shape (as shown in FIGS. 3, 8 and 9) or may be an element formed in another shape, such as a rectangle or cylinder.

Handheld fish scale 100 includes a weight gauge assembly 500. Weight gauge assembly 500 can include a strain gauge 504 and a weight tab 502. Weight tab 502 includes an attachment slot 506. Attachment slot 506 may be a hole (as shown in FIGS. 2, 3) or be a void or slot of another shape within weight tab 502 such that an item to be weighed using handheld fish scale 100, can be attached or hung from weight tab 502.

Handheld fish scale 100 includes a power source 120 (e.g., batteries) and a controller 124. The controller 124 is configured to control the electronic components (e.g., strain gauge 504, display screen 108) of the handheld fish scale 100. The controller 124 includes, one or more processors and one or more memory devices, the one or more memory devices configured to store instructions that when executed by the one or more processors cause the one or more processors to perform operations. The operations can include obtaining a measurement signal from the strain gauge 504, determining the weight of an item attached to weight tab 502, and generating one or more output signals based on said determination, and displaying information concerning the measured weight on display screen 108. One or more conductors 122 can pass through handle cavity 118 and pass through rotatable alignment element 600 to provide power and signal(s) between weight gauge assembly 500, power source 120 and controller 124. Conductors 122 can be one or more power wires or signal wires.

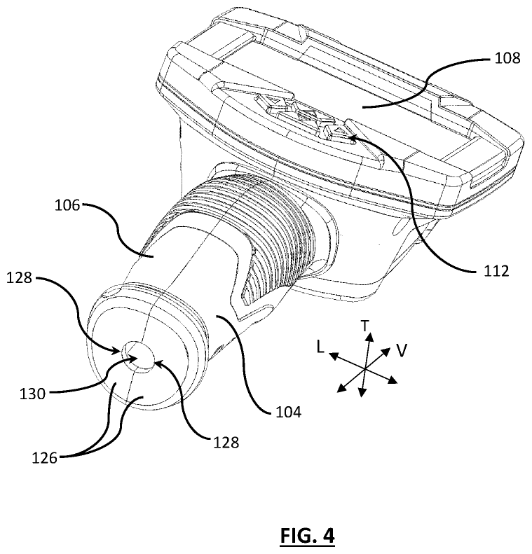

Referring now to FIG. 4. FIG. 4 depicts a bottom perspective view of the body of the handheld fish scale of FIG. 1, with the weight gauge assembly 500 and rotatable alignment element 600 removed for clarity. The first handle section 104 and second handle section 106 each include bottom surface 126. Each bottom surface 126 includes a cutout 128, such that when the first handle section 104 and second handle section 106 are attached or joined, the cutout 128 of the first handle section 104 and the cutout 128 of the second handle section 106 form a passageway 130 extending in a vertical direction V from bottom surface 126 into handle cavity 118. It should be appreciated that while passageway 130 is depicted in FIG. 4 as being cylindrical, passageway 130 can be of another shape and/or that corresponds with shaft 604 of rotatable alignment element 600.

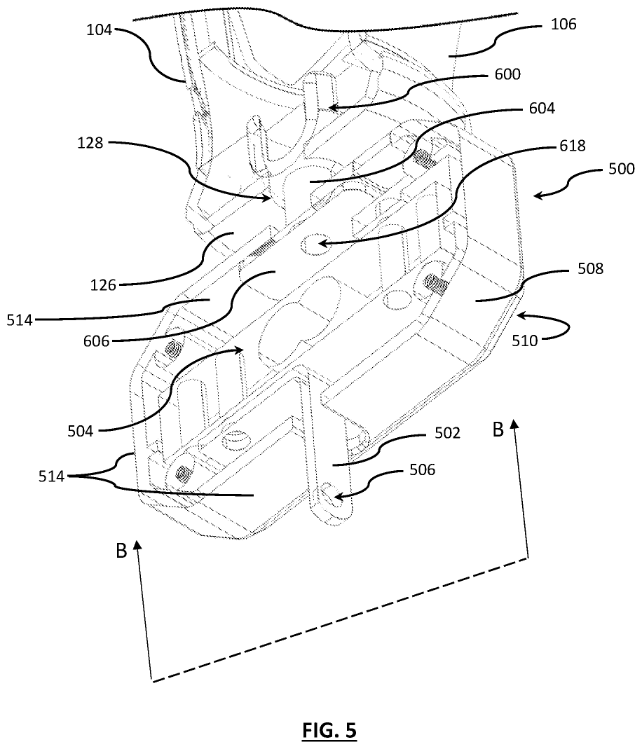

FIG. 5 depicts a partial bottom perspective sectional view of the handheld fish scale of FIG. 1 taken along the B-B section line of FIG. 2. As shown in FIG. 5, weight gauge assembly 500 includes a gauge enclosure 508. It should be appreciated that the ornamental shape of gauge enclosure 508 may be comprised of another ornamental shape or configuration. As shown in FIG. 5, gauge enclosure 508 includes a front panel 510 and a rear panel 512 (shown in FIG. 2). Gauge enclosure 508 also includes a plurality of walls 514 which extend, in a transverse direction T, between front panel 510 and rear panel 512.

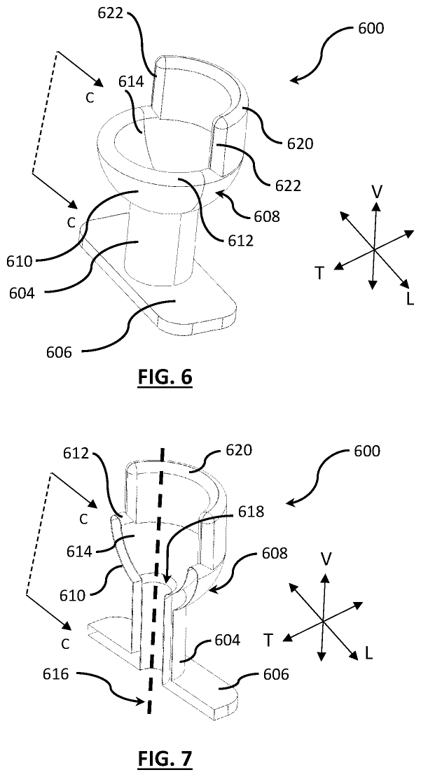

Referring now to FIG. 6 and FIG. 7. FIG. 6 depicts a perspective view of a rotatable alignment element 600 of the handheld fish scale 100 of FIG. 1. FIG. 7 depicts a sectional view of the rotatable alignment element of FIG. 6 taken along the C-C section line of FIG. 6. Rotatable alignment element 600 and the components thereof may be integrally formed as a single piece or formed separately and joined or attached. Rotatable alignment element 600 includes a base 606. Base 606 extends along a plane along a transverse direction T and a lateral direction L. Base 606 is attached to shaft 604. Rotatable alignment element 600 includes a hemispherical rotational element 608. Hemispherical rotational element 608 includes a glide surface 610 and a rim 612. The glide surface 610 is the exterior curved surface or cap area of the hemispherical rotational element 608. Rim 612 is the area of the hemispherical rotational element 608 with the largest circumferential measurement. In some embodiments of the present disclosure, hemispherical rotational element can include a depressed inner surface 614 which forms a bowl. Shaft 604 extends between glide surface 610 and base 606, in a vertical direction V, along a vertical axis 616. Rotatable alignment element 600 can also include a guard 620. Guard 620 can be one or more projections extending, in a vertical direction V, from rim 612. In some embodiments guard 620, may be a single projection while it other embodiments guard 620 may be multiple projections from rim 612. Guard 620 includes one or more striking surfaces 622. Shaft 604 includes a cylindrical channel 618 extending, in a vertical direction V along axis 614, from inner surface 614 to base 606. Channel 618 may vary in size and diameter and, in some embodiments, is dependent upon the size of the conductors 122 passing through channel 618 between control board 124, power source 120 and weight gauge assembly 500.

Referring again to FIG. 5, gauge enclosure 508 is attached to base 606 or rotatable alignment element 600, such that gauge enclosure 508 is not in physical contact with scale body 102. In some embodiments (such as those shown in FIGS. 5, 8 and 10) base 606 of rotatable alignment element 600 can be positioned within the gauge enclosure 508. In this way, one or more of the gauge enclosure walls 514 can be attached to or supported by base 606 of rotatable alignment element 600.

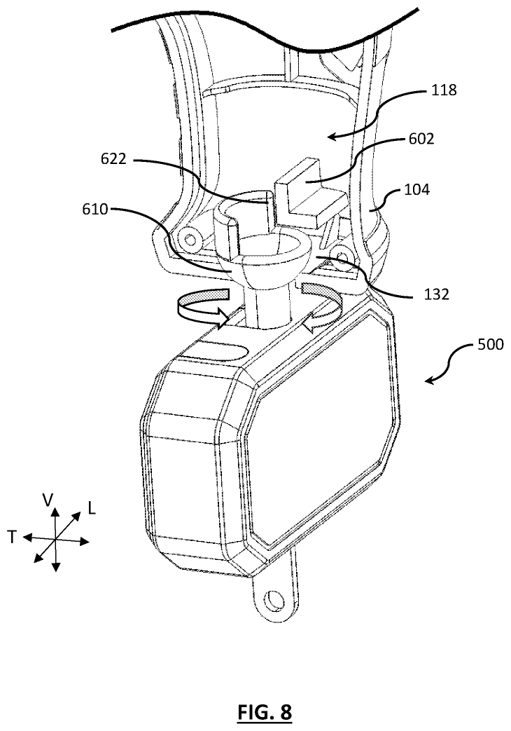

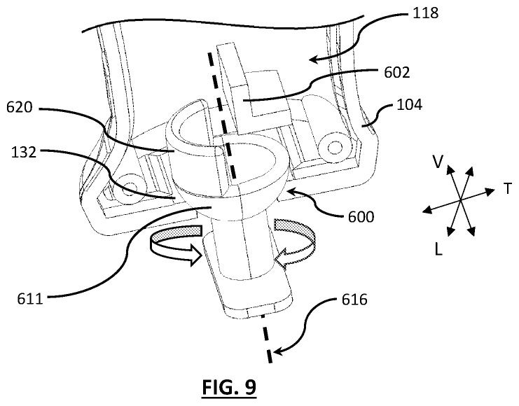

Referring now to FIGS. 8 and 9. FIG. 8 depicts a partial side perspective view of the handheld fish scale 100 with the second handle section 106 removed for clarity. FIG. 9 depicts a bottom perspective view of the handheld fish scale 100, with the second handle section 106 removed for clarity and with the weight gauge assembly 500 removed for clarity. As shown in in FIGS. 8 and 9, a portion of rotatable alignment element may be positioned within handle cavity 118, such that at least a portion of glide surface 610 is in movable (rotational and tilting) physical contact with, and supported by, the inner floor surface 132 of the bottom covers 126 of first handle section 104 (not shown) and second handle section 106. In this way, rotatable alignment element 600 and weight gauge assembly 500 are movable with respect to scale body 102. More specifically, rotatable alignment element 600 can rotate about axis 616, which is positioned within the center of channel 618. More specifically, glide surface 610 can slide or glide against inner floor surface 132 such that rotatable alignment element 600 rotates about axis 616. In some embodiments, rotatable alignment element 600 can rotate about axis 616 until one or more of the striking surfaces 622 comes into physical contact with one or more of the stop bosses 602. In this manner striking surfaces 622 and stop bosses 602 can prevent rotatable alignment element 600 from rotating 360 degrees or more (or another desired angle) about axis 616, which protects conductors 122 from becoming twisted and/or damaged.

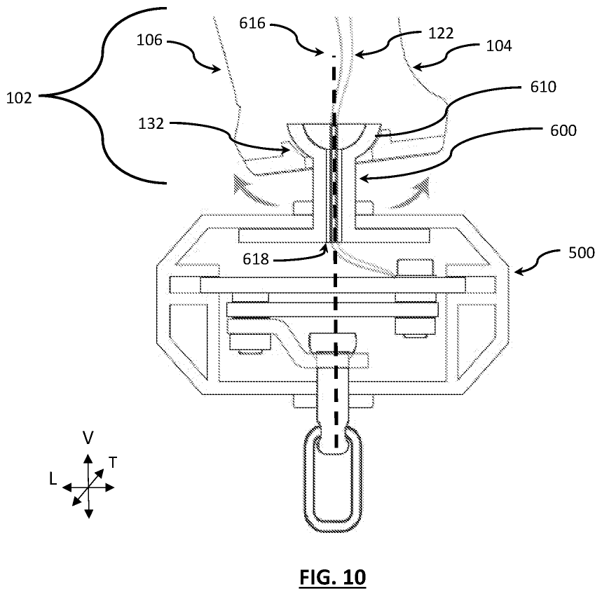

Referring now to FIG. 10 which depicts a partial cutaway view of a portion of handheld fish scale 100 according to exemplary embodiments of the present disclosure. As shown in FIG. 10, rotatable alignment element 600 can tilt relative to axis 616, such that channel 618 remains in a vertical direction V, when scale body 102, is not held in a vertical direction V, which is parallel to axis 616.

In some embodiments, rotatable alignment element 600 can tilt relative to scale body 102 until one or more of the striking surfaces 622 comes into physical contact with one or more of the stop bosses 602. In some embodiments, rotatable alignment element 600 can tilt relative to scale body 102 until any portion of the guard 620 comes into contact with inner wall 116 of first handle section 104 or inner wall 116 of second handle section 106. In this manner guard 620 can prevent rotatable alignment element 600 from tilting 90 degrees or more relative (or another desired angle) to scale body 102, which protects conductors 122 from becoming twisted and damaged. In this way, the rotatable alignment element can permit movement of the scale body 102 but allow weight gauge assembly 500 to self-align with the item being weighed, so both remain aligned in a direction that is parallel to vertical direction V, irrespective of the position at which the scale body 102 is held or positioned by a user.

Although specific features of various embodiments may be shown in some drawings and not in others, this is for convenience only. In accordance with the principles of the present disclosure, any feature of a drawing can be referenced and/or claimed in combination with any feature of any other drawing.

This written description uses examples for the disclosure, including the best mode, and also to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A handheld fish scale, the fish scale comprising:
a scale body;
a weight gauge assembly;
a rotatable alignment element including a hemispherical rotational element, a base, and a shaft, wherein the shaft extends between the hemispherical rotational element and the base; and
wherein the hemispherical rotational element is in rotational contact with the scale body, and the base is attached to the weight gauge assembly.

2. The handheld fish scale of claim 1, wherein the rotatable alignment element further comprises:
a glide surface;
a rim; and
an inner surface forming a bowl.

3. The handheld fish scale of claim 2, wherein the shaft comprises a channel extending between the inner surface of the rotatable alignment element to the base.

4. The handheld fish scale of claim 3, wherein the scale body further comprises:
a first handle section with a first cutout;
a second handle section with a second cutout; and
wherein the first handle section is attached to the second handle section.

5. The handheld fish scale of claim 4, wherein the first cutout and the second cutout form a passageway when the first handle section is attached to the second handle section.

6. The handheld fish scale of claim 5, wherein the first handle section and the second handle each include an outer handle wall and an inner handle wall and wherein both of the inner handle walls form a handle cavity.

7. The handheld fish scale of claim 6, wherein the hemispherical rotational element is positioned within the handle cavity and the shaft extends through the passageway.

8. The handheld fish scale of claim 7, wherein the rotatable alignment element further comprises a guard extending from the rim.

9. The handheld fish scale of claim 8, wherein the guard comprises a plurality of protrusions extending from the rim.

10. The handheld fish scale of claim 9, wherein the first handle section further comprises an alignment stop boss extending from the inner wall of the first handle section toward the inner wall of the second handle section.

11. The handheld fish scale of claim 10, wherein the guard includes one or more striking surfaces.

12. The handheld fish scale of claim 11, wherein the scale further comprises one or more conductors extending between a power source and the weight gauge assembly, wherein said conductors pass through the channel of the rotatable alignment element.

13. The handheld fish scale of claim 11, wherein the second handle section further comprises an alignment stop boss extending from the inner wall of the second handle section toward the inner wall of the first handle section.

14. The handheld fish scale of claim 12, wherein the weight gauge assembly comprises:
a front panel;
a rear panel; and
a plurality of walls extending between the front panel and rear panel, wherein the plurality of walls, front panel and rear panel form a gauge enclosure and wherein the base of the rotatable alignment element is immovably attached to an inner surface of, at least, one of the plurality of walls of the gauge enclosure.

15. The handheld fish scale of claim 14, wherein the weight gauge assembly comprises a strain gauge disposed within the gauge enclosure.

16. The handheld fish scale of claim 11, wherein the guard and stop boss are positioned within the handle cavity and oriented with respect to one another to prevent the weight gauge assembly from coming into physical contact with the scale body.

17. A handheld scale, the scale comprising:
a scale body;
a weight gauge enclosure with a weight tab; and
a rotatable alignment element extending between the scale body and weight gauge enclosure; and
wherein the rotatable alignment element is configured to cause the weight gauge and weight tab to remain in a vertical position irrespective of the position of the scale body.
